(19) United States
(12) Patent Application Publication
(10) Pub. No.: US 2006/0265958 A1
(43) Pub. Date: Nov. 30, 2006

(54) Device for actuating a vehicle window and a vehicle door

(76) Inventor: Laurent Cheramy, Vieilles Maisons Sur Joudry (FR)

Correspondence Address: CARLSON, GASKEY & OLDS, P.C., 400 WEST MAPLE ROAD, SUITE 350, BIRMINGHAM, MI, 48009, US

(21) Appl. No.: 11/435,372

(22) Filed: May 15, 2006

(30) Foreign Application Priority Data
May 17, 2005 (FR) 05 04 920

(51) Int. Cl. E05F 11/38

(52) U.S. Cl. 49/350; 49/349; 49/348

(57) ABSTRACT

A vehicle door includes a door shell, a window and a window actuation mechanism to open and close the window. The window actuation mechanism is designed to tilt the window on a pivot point located approximately at one end of an edge of the window. The door shell does not receive the window in an open position. A large volume of space can therefore be freed up within the door shell for fittings. The entire the door shell may be regarded as a dry space. The sealing of the door shell is thus simplified.

### REFERENCE TO RELATED APPLICATION

This application claims priority to French Patent Application FR 05 04 920 filed on May 17, 2005.

### BACKGROUND OF THE INVENTION

This invention relates generally to a vehicle opening frame, such as a vehicle side door, and in particular to a frameless door. This invention relates more particularly to an actuation device for a vehicle window designed to move the window from a closed position to an open position and vice-versa.

According to a method known per se, vehicle opening frames include a door shell containing mechanical and electrical components, such as, for example, a window regulator, a lock, a loudspeaker and a central electronic control unit, if applicable. The window regulator is designed to actuate the movement of a window of the opening frame. Window regulators are described, for example, in US A6141910, EP A1028014 and US A6029403.

The known window regulators actuate the window between an open position in which the window is housed in a door shell and a closed position in which a lower edge of the window is held in the door shell and an upper edge of the window rests in a door frame or against a roof seal in the case of a frameless door. Conventionally, the window is moved between the open position and the closed position by driving at least one slider attached to the window by a cable wound on a drum driven by a motor or a crank. One end of the cable drives the slider or sliders from a lower stop position to an upper stop position by rotating the drum in a first direction of rotation when the window is closed, and the other end of the cable drives the slider or sliders from the upper stop position to the lower stop position by rotating the drum in a second direction of rotation when the window is opened. Most window regulator mechanisms employ guide rails. Other mechanisms use an actuation arm that engages a sector.

The window regulator devices described above are relatively bulky and occupy most of a volume of the door shell. The door shell must contain the guide rails for the sliders and must also leave space to prevent interference with the operation of the drive cables. The door shell must also keep a free volume of space corresponding to the space needed by the window to occupy the door shell in the open position. This space requirement of the window regulator limits the fitting options in the door shell.

Moreover, it is known to divide the door shell into two areas, namely a so-called wet space which water and dust are able to enter by running down the window and a so-called dry space. The door shell includes an increasing number of electronic components that must be especially well protected from inclemental weather. The sealing of the door is therefore handled separately for the dry space and the wet space, which makes designing the door and positioning the components within the door more complex. Thus, for a window regulator, it is preferable for the drive motor and the electronic unit to be located in the dry space, and the window drive drum and cable to be located in the wet space of the opening frame. This arrangement of the window regulator is described in particular in patent US A6427386.

There is therefore a need for an actuation device for a window that would occupy less space in a door shell and simplify the task of sealing the door shell.

### SUMMARY OF THE INVENTION

The present invention provides a vehicle window that pivots toward an outside of a door shell about a pivot point located approximately at one end of an edge of the window, rather than having the window slide into the door shell in the open position.

The invention proposes to tilt the window outside the door shell between a closed position and an open position. More specifically, the invention provides an actuation device for a vehicle window including a structural component attached to one end of an edge of the window and designed to be driven rotatably with a center of rotation of the structural component constituting a pivot point for the window.

According to one embodiment, the actuation device includes a mechanical connection between the structural component and a drive device. According to one embodiment, the actuation device also includes a rear view mirror attached to the structural component. According to one embodiment, a rear view mirror control and/or adjustment components also pass through the pivot point of the window. According to one embodiment, the structural component includes a plate overmolded onto the window.

The invention also relates to a vehicle window including an actuation device according to the invention that is attached to one end of a lower edge of the window. According to one embodiment, the window includes a sealing joint overmolded along an upper edge of the window. According to one embodiment, the sealing joint extends along the edge of the window opposite the pivot point. According to one embodiment, the window includes a light emitting and receiving component arranged at one end of the lower edge of the window and a light reflector arranged at the other end of the lower edge of the window.

The invention also relates to a vehicle opening frame including a door shell, a window and an actuation device for opening and closing the window. The actuation device is designed to tilt the window outside the door shell on a pivot point located approximately at one end of an edge of the window.

According to the embodiment, the opening frame according to the invention also includes one or more of the following characteristics. The pivot point can located approximately at one end of the lower edge of the window. The actuation mechanism can be designed to make the window tilt around an axis of rotation approximately perpendicular to a plane of the door shell. The actuation device can be designed to make the window tilt around an axis of rotation that is approximately perpendicular to a half plane comprised within an acute angle formed between the plane of the door shell and the half plane of the window in the closed position. The door shell can include a groove designed to receive the lower edge of the window in the closed position.

The invention also proposes a method for opening a vehicle window according to the invention. The method includes the steps of actuating a drive motor to set in rotation a structural component attached to one end of an edge of the window and tilting the window towards a top of the vehicle about a pivot point located at a center of rotation of the structural component.

The invention also proposes a method for closing a vehicle window according to the invention. The method includes the steps of actuating a drive motor to set in rotation a structural component attached to one end of an edge of the window and tilting the window towards a bottom of the vehicle about a pivot point located at a center of rotation of the structural component. According to one characteristic, the method for closing the window also includes the steps of transmitting a light signal along a lower edge of the window, receiving a return light signal along the lower edge of the window, and interrupting actuation of the drive motor if the return light signal is not received.

The invention also proposes a method for opening a vehicle opening frame according to the invention including the steps of detecting a frame opening command, actuating a drive motor to set in rotation a structural component attached to one end of an edge of a window, tilting the window towards a top of the vehicle about a pivot point located at a center of rotation of the structural component at a pre-determined height to release a vehicle roof seal, and opening a door shell.

The invention also proposes a method for closing a vehicle opening frame according to the invention including the steps of closing a door shell, actuating a drive motor to set in rotation a structural component attached to one end of an edge of a window, and tilting the window towards a bottom of the vehicle about a pivot point located at a center of rotation of the structural component at a predetermined height to engage with a vehicle roof seal.

### BRIEF DESCRIPTION OF THE DRAWINGS

Other characteristics and advantages of the invention will become apparent on reading the following detailed description of the embodiments of the invention, given as examples only and with reference to the drawings, which show:

FIG. 1 illustrates a diagrammatic view of an opening frame according to the invention with a window in a closed position;

FIG. 2 illustrates a diagrammatic view of the opening frame according to the invention with the window in an open position;

FIG. 3 illustrates a diagrammatic view of an actuation device for the window according to the invention;

FIG. 4 illustrates a detailed diagrammatic view of FIG. 3 in cross-section; and

FIG. 5 illustrates a diagrammatic view in cross-section of the opening frame according to the invention with the window in the closed position.

### DETAILED DESCRIPTION OF PREFERRED EMBODIMENTS

The invention proposes a new type of vehicle window actuation device. The device includes a structural component attached to one end of an edge of the window, for example an insert made up of a metal plate partially overmolded onto one edge of the window. The structural component is designed to be driven rotatably, and thus rotatably drives the window to which it is attached. The center of rotation of the structural component defines a pivot point of the window, which may tilt between a closed position (in which the lower edge of the window is housed in the top of the door shell) and an open position (in which the lower edge of the window is raised away from the door shell).

With the window actuation device according to the invention, the door shell no longer receives the window in the open position and no longer houses a drive cable or rails. A large volume of space can thus be freed up in the door shell. Moreover, it is possible to limit a wet space in the door shell to a localized volume on a periphery of the door shell rather than a large thickness over the entire area of the door shell as in the prior art. Sealing the door shell is thus simplified.

The invention puts forward the hypothesis that the window is rarely open while the vehicle is in motion, in particular in the case of air conditioned vehicles and vehicles which have been optimized in respect of engine and airflow noise. When the vehicle is stationary, or possibly while moving at a slow speed, the window could therefore be opened in a way other than sliding the window into the door shell. Nevertheless, depending on the dimensions of the actuation device of the invention and the material used to manufacture the window, opening the window while travelling at cruising speed is possible.

A vehicle opening frame according to the invention and equipped with a window actuation device according to the invention will be described with reference to the attached figures. Conventionally, a vehicle is defined in relation to three directions: a direction X of travel of the vehicle, a vertical direction Z from the ground upwards, and a lateral direction Y forming a direct axis system with the directions X and Z. The expressions “top,” “bottom,” “above” and “below” used in the description below refer to the figures, which show an opening frame as it would be arranged on a vehicle.

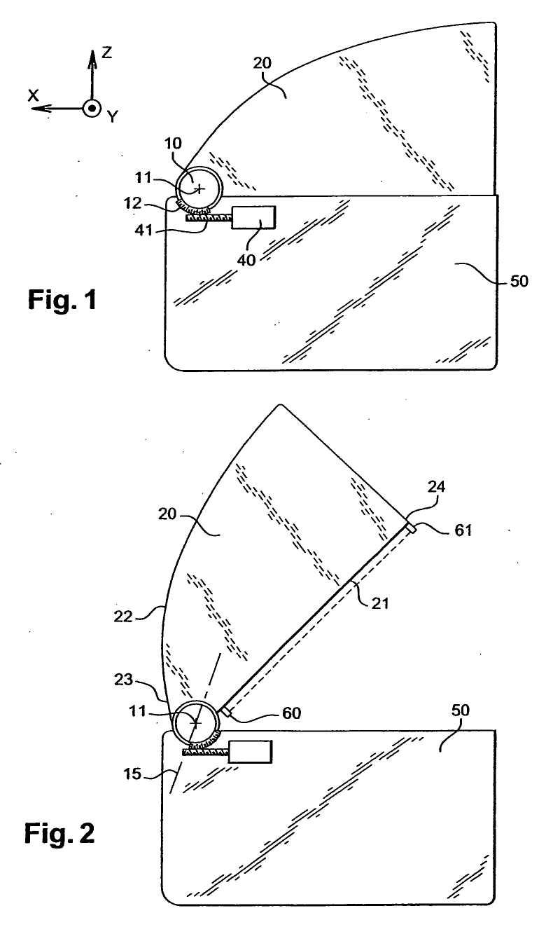

FIG. 1 shows a vehicle opening frame, illustrated as a frameless front door, with a window 20 in a closed position. FIG. 1 shows a door shell 50 occupying a lower section of the opening frame and a window 20 occupying an upper section of the opening frame. FIG. 1 also shows a structural component 10 attached to the window 20. The structural component 10 has a first part securely attached to the window 20, for example overmolded, clipped or fixed by any way onto the window 20 and a second part arranged in the door shell 50. FIG. 1 also shows a drive motor 40 that is arranged to drive the structural component 10 rotatably, for example by a worm 41 that engages a toothed sector 12 securely attached to the structural component 10. A pivot point 11 (or center of rotation) is thus defined on the structural component 10 as the fixed point when the structural component 10 is driven by the drive motor 40.

FIG. 2 shows the opening frame in FIG. 1 with the window 20 in an open position. FIG. 2 shows the window 20 after it has pivoted towards the outside of the door shell 50. In the open position, the window 20 does not slide inside the door shell 50, but tilts on the pivot point 11 constituted by the center of rotation of the structural component 10.

With reference to the window 20 as mounted on the vehicle opening frame, the window 20 includes a lower edge 21, an upper edge 22, a front end 23 of the lower edge 21 and a rear end 24 of the lower edge 21. In FIGS. 1 and 2, the structural component 10 is attached to the front end 23 of the lower edge 21 of the window 20. The structural component 10 could, however, be attached to the rear end 24 of the lower edge 21, (for example in the case of a window 20 in a rear door of a vehicle) or to a rear end of the upper edge 22. In the rest of the description, the movement of the window 20 pivoting about a lower front pivot point 11 of the window 20 will be described, although the pivot point 11 could be located at another end of an edge of the window 20.

FIG. 2 shows the components of an anti-pinch device on the lower edge 21 of the window 20, the operation of which will be described in detail below. A light emitting and receiving optoelectronic component 60, such as a diode integrated with a phototransistor, is arranged at the first end 23 of the lower edge 21 of the window 20. A reflective component 61, such as a mirror, is arranged at the rear end 24 of the lower edge 21 of the window 20. Preferably, the light emitting and receiving optoelectronic component 60 is placed on the structural component 10 of the window actuation device for reasons of ease of fastening and electrical wiring. When the window 20 is in the open position as illustrated in FIG. 2, the light emitting and receiving optoelectronic component 60 emits a light signal along the lower edge 21 of the window 20. This signal is reflected by the reflective component 61 back towards the light emitting and receiving optoelectronic component 60. The reflective component 61 may be slightly angled so that the paths of the outward and return light signals are not confused, but cross each other over the thickness of the window edge. The emission and return of a light signal along the lower edge 21 of the window 20 from and to a single light emitting and receiving optoelectronic component 60 is possible because the window 20 has a reduced longitudinal curve of the order of 1.5 mm and generally below 3 mm.

FIG. 2 also shows an axis of rotation 15 around which the window 20 tilts when the structural component 10 is driven rotatably around the pivot point 11. This axis of rotation 15 may be approximately perpendicular to a plane of the door shell 50, i.e., the window 20 tilts upwards and towards the front of the vehicle on opening while remaining in the same plane as it occupied in the closed position. With reference to the vehicle labelling system (X, Y, Z) as defined above, the window 20 tilts in a plane (X, Z) between the closed position and the open position. The axis of rotation 15 may also form an angle perpendicular to the plane of the door shell 50 as a function of the degree of inclination of the body structure formed by the side pillar and the roof with which the upper edge 22 of the window 20 cooperates in the closed position. In particular, the axis of rotation 15 may be approximately perpendicular to a half plane comprised within an acute angle formed by the plane of the door shell 50 and the plane of the window 20 in the closed position. The window 20 may thus tilt both upwards and towards the front of the vehicle (and also slightly towards the interior of the vehicle in the direction Y) to position itself above the roof. In the open position, the window 20 thus clears a larger field of vision for the vehicle passenger, guides the flow of air away from the passengers when the vehicle is in motion, and provides protection from rain, which is less able to enter from above.

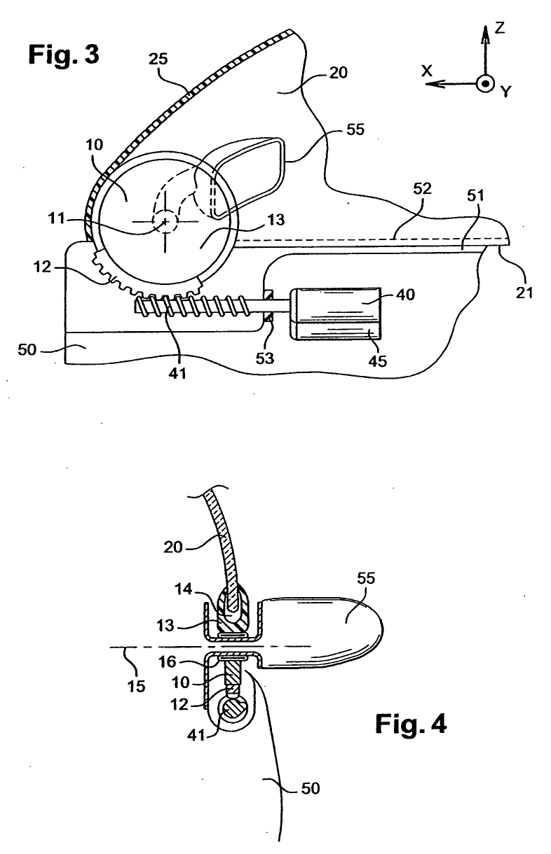

FIGS. 3 and 4 show in detail the window actuation device according to the invention. FIG. 3 shows the door shell 50 and the window 20 in the closed position. FIG. 3 also shows the structural component 10 attached to the front end 23 of the lower edge 21 of the window 20. The structural component 10 may be made up of an insert made up of a metal or plastic plate 13 with a diameter of approximately 10 to 20 cm, including a part attached to the window 20 and a part fixed to the door shell 50 in such a way that it can slide rotatably. The part of the structural component 10 attached to the window 20 may be a plate positioned on the external face of the window 20 or a double plate sandwiching the end of the window 20. The connection between the window 20 and the structural component 10 may be made by injecting a material 14 between the surface or surfaces of the window 20 and the plate 13 or plates of the structural component 10, such as an injection of rubber, an elastomer or a thermoplastic. FIG. 4 shows the connection between the structural component 10 and the window 20 and the door shell 50 in cross-section. The structural component 10 is a plate 13 split to sandwich the edge of the window 20. The injected material 14 attaches the structural component 10 to the window 20. The plate 13 is drilled at the axis of rotation 15 and has roller bearings or a bearing 16 engaging with the structure of the door shell 50.

FIGS. 3 and 4 show a sector 12 attached to the structural component 10. The sector 12 may be in a single piece with the part of the structural component 10 remaining inside the door shell 50. The sector 12 may be a toothed sector 12 that engages with a worm 41 of a drive motor 40. The drive motor 40 may be coupled to a electronic control device 45 that controls the setting in rotation of the drive motor 40 in one direction or the other to drive the rotation of the structural component 10 and open or close the window 20. The electronic control device 45 may also control the stopping and reversal of the drive motor 40, in particular in the event of the implementation of an anti-pinch function, which will be described below. Of course, the drive motor 40 and the sector 12 may be modified by intermediate gear reduction or reduction gearing to obtain the most economical and compact drive possible, for example by inserting reduction gears between the worm 41 and the sector 12. The worm 41 may be fastened to the sector 12 by a bearing or a half-bearing (not illustrated) that maintains the mechanical drive link between the worm 41 and the sector 12. The sector 12 may also be replaced by a bar that pulls and pushes a lever securely attached to the structural component 10. The various points on the periphery of the toothed sector 12 may be equidistant from the pivot point 11 of the structural component 10 so that the torque applied by the drive motor 40 to the structural component 10 is constant over the whole travel of the window 20.

FIG. 3 also shows a window channel 51 in the door shell 50 designed to receive the lower edge 21 of the window 20 in the closed position. A window sealing strip 52 limits the ingress of rain and dust into the window channel 51. The window channel 51 includes a longitudinal groove and has a recess accommodating the window actuation mechanism. A so-called “wet space” delimited by the window channel 51 and a so-called “dry space” in the remainder of the door shell 50 are thus defined. Preferably, the drive motor 40 and the electronic control device 45 are located in the dry space of the door shell 50. A gasket 53 may surround the worm 41 of the drive motor 40. The light emitting and receiving optoelectronic component 60 is located in the wet space. The light emitting and receiving optoelectronic component 60 must therefore be chosen appropriately.

FIG. 3 shows that the drive motor 40 is placed near the upper front edge of the door shell 50 so that the structural component 10 located at the front end 23 of the lower edge 21 of the window 20 can be driven. This positioning of the drive motor 40, close to the hinges of the door shell 50, enables the vibrations experienced by the drive motor 40 when the door is slammed to be reduced. Thus, the stresses on the drive motor 40 are reduced, which reduces the risks of breakdown and the risks of disturbance to the angular position of the drive motor 40.

FIGS. 3 and 4 also show a rear view mirror 55 that may be fixed directly to the plate 13 of the structural component 10. The axis of the arm of the rear view mirror 55 may pass through the pivot point 11 of the structural component, i.e., through the pivot point of the window 20. Thus, when the window 20 is in the open position, the rear view mirror 55 is driven with the window 20 to clear the field of vision of the passenger as much as possible. Opening of the window 20 is rarely activated when the vehicle is in motion, and therefore use of the rear view mirror 55 is not indispensable. Nevertheless, the rear view mirror 55 may remain fixed to the center of the structural component 10, as shown in FIG. 4. Alternatively, the body and/or the mirror of the rear view mirror 55 may tilt in a direction of rotation opposite to the rotation of the structural component 10 driven by the drive motor 40 in order to keep the rear view mirror 55 directed towards the rear of the vehicle. Thus, the axis of the rear view mirror 55 remains fixed when the window 20 is tilted into the open position or the closed position, and the use of the rear view mirror 55 may be retained when the window 20 is open, for example with the vehicle travelling at low speed.

FIG. 3 also shows a sealing joint 25 overmolded along the upper edge 22 of the window 20. The sealing joint 25 may include a rigid or semi-rigid insert, for example made of metal or thermoplastic, overmolded onto the upper edge 22 of the window 20 by injecting a material, such as rubber or another elastomer. The sealing joint 25 may be overmolded directly onto the window 20, even if this increases the thickness of the window 20 on its upper edge 22, as the window 20 does not slide through a window sealing strip to enter the door shell 50 when fully open as in the prior art. The sealing joint 25 may therefore be placed on the window 20, rather than on the roof of the vehicle as is generally the case in the prior art. The number of parts to be assembled on the opening frame is therefore reduced by the integration of the sealing joint 25 with the window 20. Furthermore, the integration of the sealing joint 25 with the window 20 may allow for a continuous glazed surface to be achieved with a glazed roof if required, as well as with the windscreen or rear window of the vehicle.

The sealing joint 25 overmolded onto the window 20 may be continued on the edge of the window 20 opposite the pivot point 11 of the window 20 to cooperate with another window, for example a rear side window or a pillar of the body. If the sealing joint 25 is extended to cooperate with another window, it may have an overmolded profile towards the interior of the vehicle to produce a stylistic effect of continuity of the glazed surface between the two windows.

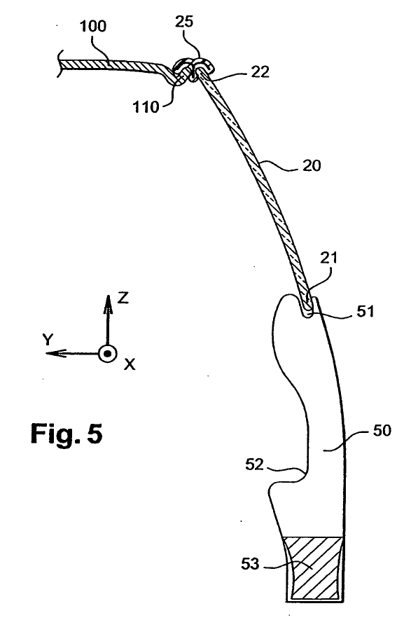

FIG. 5 is a cross-sectional view of a vehicle opening frame according to the invention. FIG. 5 shows the sealing joint 25 on the upper edge 22 of the window 20 coming into contact with a roof 100 of the vehicle with the window 20 and a door in a closed position. The sealing joint 25 may have a suitable shape to engage with a gutter 110 of the roof 100. For example, the sealing joint 25 may include a first flexible profile (made of an elastomer, for example) designed to perform the sealing function and a second rigid profile (made of metal or plastic, for example) in the shape of an “M.” One bridge of the “M” clasps the window 20, and the other bridge of the “M” extends to clasp the flexible structural component and the roof gutter 110 in the closed position. Both the flexible and the rigid inserts are overmolded along the upper edge 22 of the window 20. Thus, in the closed position as illustrated in FIG. 5, the sealing joint 25 ensures sealing of the vehicle passenger compartment with the rigid insert engaged with the roof gutter 110 and with the flexible insert compressed between the window 20 and the return of the gutter 110 of the roof 100.

FIG. 5 also shows a cross-section of the door shell 50. FIG. 5 shows the groove in the window channel 51 designed to receive the lower edge 21 of the window 20 in the closed position. The sealing of the door shell 50 is simplified, in particular by the absence of intrusion by the window 20 into the door. The conventional sealing strip may also be overmolded onto the window 20 and the door shell 50 treated as an entirely dry space, with the exception of a small section including the connection of the actuation device receiving the part of the structural component 10 attached to the door shell 50, as described above. The seal on the lower edge 21 of the window 20 now only has the function of holding the window 20 flexibly and avoiding vibrations in the direction Y of the closed window 20.

Moreover, FIG. 5 shows that the door shell 50 does not have a volume reserved to receive the window 20 in the open position. It is thus possible to fit the door shell 50 with larger storage compartments and to increase the side reinforcement, such as, for example, employing extended pelvic protection or airbags.

The costs to repair the window 20 and/or the opening frame actuation device according to the invention may be reduced. The window actuation device according to the invention has fewer parts than the window regulators according to the prior art. The risks of breakdown are therefore reduced, and disassembly and reassembly of the device in the event of repair are simplified. Moreover, in the event of a side impact, in general at the bottom of the door shell 50, the window actuation device is less exposed and may therefore be more easily disassembled and reassembled on a new door shell 50.

The operation of the vehicle window actuation device according to the invention will now be described. When the window 20 is in the closed position (FIGS. 1 and 5), the lower edge 21 of the window 20 is housed in the groove of the window channel 51 of the door shell 50, and the upper edge 22 of the window 20 rests against the roof 100 of the vehicle with the sealing joint 25 held against the gutter 110 of the roof 100.

A user of the vehicle who wishes to effect opening of the window 20 may actuate a control, for example a button on the internal trim of the door shell 50. An electronic control device 45 receives and interprets this command and may initiate the running of the drive motor 40 in a first direction of rotation. The electronic control device 45 may, if appropriate, prevent the running of the drive motor 40 that drives the window 20 if the vehicle is in motion or is travelling at a speed exceeding a pre-determined value. For example, the electronic control device 45 of the window drive motor 40 may receive a signal from a speed sensor attached to the vehicle and limit the ability to open the window 20 or just the extent and speed of opening of the window 20.

If the conditions of motion of the vehicle permit, the electronic control device 45 commands the running of the drive motor 40 and the rotation of the worm 41. The toothed sector 12 will then engage with the worm 41 and drive the structural component 10 rotatably around the pivot point 11. The rotation of the structural component 10 will drive the window 20 to tilt upwards and forwards on the pivot point 11 and around the axis of rotation 15. The rotation of the window 20 jointly with the structural component 10 will continue until the motor software issues a motor stop command or the structural component 10 or the window 20 is brought to a mechanical stop having reached a fully open position (FIG. 2).

A user then wishing to effect the closing of the window 20 may actuate a control, for example a button on the internal trim of the door shell 50. The electronic control device 45 receives and interprets this command and initiates the running of the drive motor 40 in a second direction of rotation. The toothed sector 12 will then engage with the worm 41 and drive the structural component 10 rotatably in the reverse direction around the pivot point 11. The rotation of the structural component 10 will drive the window 20 to tilt downwards and backwards on the pivot point 11 and around the axis of rotation 15. The rotation of the window 20 jointly with the structural component 10 will continue until the motor software issues a stop command or the structural component 10 or the window 20 is brought to a mechanical stop having reached its fully closed position (FIG. 2), for example with the lower edge 21 of the window 20 coming to a stop in the window channel 51 of the door shell 50.

On closure of the window 20, in order to avoid the pinching of a part of the body (in particular a finger) between the lower edge 21 of the window 20 and the upper edge of the door shell 50, the electronic control device 45 may activate an anti-pinch function. The anti-pinch function may include a conventional algorithm including measuring the parameters of the drive motor 40, and in particular the current passing through the drive motor 40, and the angular position of the rotor shaft of the drive motor 40. When the current value, combined with a motor position, exceeds a predetermined threshold, the electronic control device 45 interprets this as the presence of an obstacle in the path of the window 20 and commands the drive motor 40 to stop or even to reverse. The electronic control device 45 may also activate an anti-collision function when the window 20 is opened, for example with an obstacle located above the window 20, such as a low ceiling or an object on the roof 100 of the vehicle. The anti-collision function may include a conventional algorithm consisting of measuring the parameters of the drive motor 40 and in particular the current passing through the drive motor 40 and the angular position of the motor shaft. When the current value, combined with a motor position, exceeds a predetermined threshold, the electronic control device 45 interprets this as the presence of an obstacle in the path of the window and commands the drive motor 40 to stop or even to reverse.

It is possible with a window 20 according to the invention to complement or replace the conventional anti-pinch device with an optical device for detecting obstacles on the lower edge 21 of the window 20. With a window 20 according to the invention, detecting an obstacle in the path of the window 20 is performed along the lower edge 21 of the window 20 and not along the upper edge 22, as in the case of a sliding window of the prior art. The lower edge 21, in contrast to the upper edge 22, is approximately straight with a limited curve of the order of 1.5 mm. It is thus possible to emit and receive a light signal along the upper edge 21 and be almost certain that an interruption of the light signal corresponds to an obstacle in the path of the window 20. Thus, the electronic control device 45 may receive an electrical signal transmitted by the light emitting and receiving optoelectronic component 60 receiving a return light signal along the lower edge 21 of the window 20, as described with reference to FIG. 2. Such a signal may be interpreted as a binary signal, i.e., the presence or absence of the receipt of light by the light emitting and receiving optoelectronic component 60. The electronic control device 45 is thus designed to interrupt or reverse operation of the drive motor 40 when the electric signal received from the light emitting and receiving optoelectronic component 60 is interpreted as the absence of return of the light signal emitted.

The opening frame may equally be open or closed, preferably with the window 20 in the closed position. In the closed door position with the window 20 in the closed position, the door shell 50 is pushed against the bodywork of the vehicle, and the sealing joint 25 is engaged with the gutter 110 of the roof 100 (FIG. 5). To effect opening without the sealing joint 25 offering resistance to the door being pulled away from the roof 100, the sealing joint 25 must be released from the gutter 110 of the roof 100. When the electronic control device 45 detects a door opening command, the electronic control device 45 may initiate the running of the drive motor 40 over a predetermined angular distance corresponding to lifting the window 20 by a few millimeters in order to disengage the sealing joint 25 from the roof gutter 110. The door opening command may be slightly delayed in order to allow the window actuation device to perform this small lift prior to opening. The lifting of the window 20 responding to a door opening command is limited and does not result in the lower edge 21 of the window leaving the window channel 51 in the door shell 50.

Similarly, in the door open position, when the user slams the door to close it, the door shell 50 closes against the vehicle body and the lock bolt of the door lodges in the striker plate of the body in a manner known per se. The window 20 is then lowered to force the sealing joint 25 against the roof 100 and to engage it in the gutter 110 in order to ensure that the passenger compartment is effectively sealed. The electronic control device 45 may detect a door closed position by a position sensor on the lock, for example, and command the drive motor 40 to be run over an angular distance opposite to the distance corresponding to the previous lifting of the window 20 when the door was opened.

Of course, this invention is not limited to the embodiments described as examples. Thus, although the pivot point 11 of the window 20 has been described as being located at the front end 23 of the lower edge 21 of the window 20, other locations are possible by arranging the drive motor 40, the structural component 10 and the sector 12 and the worm 41 in an appropriate manner, in particular for a rear door.

Similarly, the structural component 10 and the toothed sector 12 may have different shapes from those described, the structural component 10 simply being required to be securely attached to the window 20 and designed to be driven rotatably to tilt the window 20 around a pivot point 11.

Moreover, the sealing joint 25 overmolded onto the window 20 may have a different shape from the one described, in particular in the case of an overmolded joint ensuring the continuity of a glazed surface with a roof, a windscreen and/or a rear window.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. An actuation device for a vehicle window, the actuation device comprising:
a structural component attached to one end of an edge of the vehicle window, the structural component to be driven in rotation, wherein a center of rotation of the structural component constitutes a pivot point of the vehicle window.

2. The actuation device according to claim 1, further including a drive device and a mechanical connection between the structural component and the drive device.

3. The actuation device according to claim 1, further including a rear view mirror attached to the structural component.

4. The actuation device according to claim 3, further including a rear view mirror control and adjustment components, wherein at least of the rear view mirror control and the adjustment components pass through the pivot point of the vehicle window.

5. The actuation device according to claim 1, wherein the structural component includes a plate that is overmolded onto the vehicle window.

6. A vehicle window comprising:
an actuation device including a structural component attached to one end of a lower edge of the vehicle window, the structural component to be driven in rotation, wherein a center of rotation of the structural component constitutes a pivot point for the vehicle window.

7. The vehicle window according to claim 6, further including an upper edge and a sealing joint overmolded along the upper edge.

8. The vehicle window according to claim 7, further including an edge opposite from the pivot point, wherein the sealing joint extends along the edge opposite the pivot point.

9. The vehicle window according to claim 6, further including a light emitting and receiving component arranged at the one end of the lower edge and a light reflector arranged at another end of the lower edge.

10. A vehicle door comprising:
a door shell;
a window including an edge;
an actuation device for opening and closing the window and to tilt the window outside the door shell about a pivot point located approximately at one end of the edge of the window.

11. The vehicle door according to claim 10, wherein the edge is a lower edge.

12. The vehicle door according to claim 10, wherein the actuation device tilts the window around an axis of rotation that is approximately perpendicular to a plane of the door shell.

13. The vehicle door according to claim 10, wherein the actuation device tilts the window around an axis of rotation that is approximately perpendicular to a half plane comprised within an acute angle formed between a plane of the door shell and a half plane of the window when in a closed position.

14. The vehicle door according to claim 10, wherein the edge is a lower edge and the door shell includes a groove to receive the lower edge of the window when in a closed position.

15. The vehicle door according to claim 10, wherein the actuation device for opening and closing the window includes a structural component attached to the one end of the edge of the window, the structural component to be driven in rotation, and wherein a center of rotation of the structural component constitutes the pivot point for the window.

16. The vehicle door according to claim 15, further including a drive device and a mechanical connection between the structural component and the drive device.

17. The vehicle door according to claim 15, further including a rear view mirror attached to the structural component.

18. The vehicle door according to claim 17, further including a rear view mirror control and adjustment components, wherein at least one of the rear view mirror control and the adjustment components pass through the pivot point of the window.

19. The vehicle door according to claim 15, wherein the structural component includes a plate overmolded onto the window.
